(19) United States
(12) Patent Application Publication
(10) Pub. No.: US 2006/0240196 A1
(43) Pub. Date: Oct. 26, 2006

(54) Method of producing retardation plate

(76) Inventors: Shunsuke Shutou, Ibaraki-shi (JP); Minoru Miyatake, Ibaraki-shi (JP); Naoki Tsujiuchi, Ibaraki-shi (JP); Junzou Miyazaki, Ibaraki-shi (JP); Takuya Matsunaga, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/544,338

(22) PCT Filed: Jan. 26, 2004
(86) PCT No.: PCT/JP04/00669

§ 371 Date: Feb. 27, 2006

(30) Foreign Application Priority Data
Oct. 10, 2003 (JP) 2003-352742

(51) Int. Cl. C09K 19/00

(52) U.S. Cl. 428/1.3

(57) ABSTRACT

A method is provided by which a highly functional thin retardation plate with no appearance defect can be produced. First, as shown in FIG. 1A, a solution of a liquid crystalline compound is applied on a transparent base 1 and dried, or alternatively, a liquid crystalline compound on the melt is applied on the transparent base 1, and thus a liquid crystalline compound-containing layer 2a is formed. Then, as shown in FIG. 1B, the liquid crystalline compound-containing layer 2a is brought to a liquid crystal state or a liquid state so as to form a layer 2b. An alignment substrate 3 is brought into contact with an upper portion of the layer 2a so that the liquid crystal compound is aligned in a particular direction. Then, after the liquid crystalline compound is aligned in the particular direction, as shown in FIG. 1C, the liquid crystalline compound-containing layer 2b on the melt is solidified, and the alignment substrate 3 is removed. Thus, a retardation plate 4 composed of the transparent base 1 and an optically anisotropic layer 2c is produced.

### TECHNICAL FIELD

The present invention relates to a method of producing a retardation plate that is used favorably for image display apparatuses such as, for example, a liquid crystal display (LCD).

### BACKGROUND ART

A retardation plate is an important member that realizes, by optical compensation, improved contrast and a wider viewing angle range in an image display apparatus such as a liquid crystal display or the like. For such a retardation plate, a polymer film that is stretched to be provided with an optical anisotropy and a polymer film or the like as a base on which an optically anisotropic layer containing a liquid crystalline compound is coated are used. Attention has been given particularly to the latter, with the recent trend moving toward thinner liquid crystal displays or the like.

In the production of a retardation plate, in order to form an optically anisotropic layer containing a liquid crystalline compound, it is necessary that an entire molecule of the liquid crystalline compound or a mesogenic portion thereof exhibiting a liquid crystal property be aligned orderly so as to be in a constant direction or varied continuously. To this end, for example, a method is employed in which an alignment film is formed on a base and a liquid crystalline compound further is coated on the alignment film (hereinafter, may be referred to as “an alignment film forming method”; see, for example, JP 2002-14233 A, U.S. Pat. No. 6,215,539, and U.S. Pat. No. 6,300,991). Moreover, a method also is employed in which an optically anisotropic layer is formed by coating a liquid crystalline compound on a separately prepared alignment substrate, and the optically anisotropic layer then is transferred onto a base (hereinafter, may be referred to as “a transfer method”; see, for example, JP 2631015 B2).

The following describes an outline of the alignment film forming method as an example. That is, first, a transparent base is prepared, and a solution for forming an alignment film then is coated on the transparent base so as to form a smooth film thereon. The film is subjected further to a rubbing treatment or the like so as to be provided with a liquid crystal alignment capability, and thus an alignment film is obtained. Next, on the alignment film, a solution of a liquid crystalline compound is applied and dried, or alternatively, a melt of a liquid crystalline compound is coated, so that the liquid crystalline compound is aligned. Then, the liquid crystalline compound is polymerized as required and further is solidified by cooling, thereby forming an optically anisotropic layer, and thus a retardation plate is produced. There also is a method in which another transparent base with an alignment film formed thereon further is prepared, and the liquid crystalline compound is sandwiched between surfaces of the two bases, on which the alignment films are formed, respectively, and thus is aligned (see, for example, JP 9(1997)-281480 A). Moreover, there also is a method in which instead of forming an alignment film on a transparent base, the transparent base is subjected directly to a rubbing treatment (see, for example, JP 9(1997)-281481 A).

Furthermore, the following describes an outline of the transfer method as an example. That is, first, an alignment substrate having an optical anisotropy such as, for example, a uniaxially stretched polymer film is prepared. Next, on the alignment substrate, a solution of a liquid crystalline compound is applied and dried, or alternatively, a melt of a liquid crystalline compound is coated, so that the liquid crystalline compound is aligned. Then, the liquid crystalline compound is polymerized as required and further is solidified by cooling so that an alignment state is fixed, and thus an optically anisotropic layer is formed. Meanwhile, a base is prepared, and an adhesive or a pressure-sensitive adhesive is applied thereon. The base is formed of, for example, an optically isotropic transparent film or an optically anisotropic film whose optical axis is not in an alignment direction of the liquid crystalline compound. Then, after the optically anisotropic layer is attached to the adhesive or the like, the alignment substrate is removed to complete the transfer, and thus a retardation plate is produced.

However, in the alignment film forming method, an alignment film remains as it is in a retardation plate, and in the transfer method, an adhesive or the like remains as it is in a retardation plate. From the viewpoint of an optical function of a retardation plate, the alignment film and the adhesive or the like are unnecessary and preferably are omitted as much as possible in order to achieve thickness reduction. Furthermore, the alignment film forming method may present a problem of poor adhesion between an alignment film and the optically anisotropic layer. JP 9(1997)-152509 A discloses that a modified PVA alignment film is formed on a transparent base on which undercoating (with gelatin or the like) has been applied, and thus excellent adhesion to a liquid crystal layer is obtained. However, this results in a further increase in the thickness of a retardation plate because of the application of gelatin or the like and also makes production processes complicated.

Moreover, in the alignment film forming method, performing the rubbing treatment or the like may cause scratches to be made on the surface of an alignment film. Since the alignment film remains as it is in a retardation plate, if the surface of the alignment film has scratches, the scratches themselves are recognized as a defect in the appearance of the retardation plate. In addition, when a rubbing treatment is performed, foreign substances and the like also may be fixed on the surface of an alignment film to remain inside a retardation plate along with the alignment film. The same disadvantage results also from the method in which without forming an alignment film on a transparent base, the transparent base is subjected directly to a rubbing treatment. Furthermore, the transfer method may present a problem that foreign substances and the like are bonded to a surface when an adhesive or the like is applied thereto, which causes an optically anisotropic layer to break or complete transfer to be hindered.

### DISCLOSURE OF INVENTION

With the foregoing in mind, it is an object of the present invention to provide a production method by which a highly functional thin retardation plate with no appearance defect can be produced.

In order to solve the above-mentioned problems, the production method according to the present invention is a method of producing a retardation plate in which an optically anisotropic layer is formed on a transparent base and includes process steps (1) to (4) below of:

(1) forming a liquid crystalline compound-containing layer on the transparent base without a liquid crystal alignment capability;

(2) bringing an alignment substrate with a liquid crystal alignment capability into contact with the liquid crystalline compound-containing layer so as to cause alignment of a liquid crystalline compound of the layer;

(3) fixing a state of the alignment of the liquid crystalline compound of the layer so that the optically anisotropic layer is formed; and (4) removing the alignment substrate.

As described above, unlike the conventional technique, the production method according to the present invention can avoid that an alignment film, an adhesive, scratches caused by rubbing and the like remain on the transparent base, thereby allowing a highly functional thin retardation plate with no appearance defect to be produced. Furthermore, an optically anisotropic layer containing a liquid crystalline compound can be laminated on the transparent base without an alignment film interposed therebetween, thereby eliminating problems attributable to poor adhesion between an alignment film and the optically anisotropic layer.

### BRIEF DESCRIPTION OF DRAWINGS

FIG. 1 is a view showing an example of process steps of the production method according to the present invention.

FIG. 2 is a diagram schematically showing an example of a device for performing the production method according to the present invention.

FIG. 3 is a graph showing a retardation property of a retardation plate of Example 5.

FIG. 4 is a graph showing a retardation property of a retardation plate of Example 6.

FIG. 5 is a graph showing a retardation property of a retardation plate of Example 8.

### DESCRIPTION OF THE INVENTION

The description is directed next to embodiments of the present invention.

Although the thickness of the transparent base is not particularly limited, it is preferable that the transparent base is as thin as possible in order to achieve reduction in the thickness of a retardation plate. The thickness is, for example, 20 to 120 μm, preferably 20 to 80 μm, and more preferably 20 to 40 μm.

The transparent base is “transparent” in a sense that it has such light transmittance as to be applicable to a retardation plate. The light transmittance is not particularly limited as long as it is within a range suitable for practical use. However, from the viewpoint of a function of a retardation plate, the higher the light transmittance is, the greater an advantage to be obtained. The light transmittance is ideally 100%.

Furthermore, although the transparent base may be optically isotropic, it is preferable that the transparent base has an optical anisotropy depending on, for example, a function required of a liquid crystal display in which a retardation plate is to be mounted. The optical anisotropy in this case is not particularly limited but can be, for example, an optical anisotropy with which a positive or negative A-plate retardation property is exhibited, an optical anisotropy with which a positive or negative C-plate retardation property is exhibited, an optical anisotropy with which a positive or negative O-plate retardation property is exhibited, a biaxial optical anisotropy that provides refractive index anisotropies in different directions (that is, two optical axes are provided). Each of an A-plate, a C-plate and an O-plate is a layer having a so-called uniaxial optical anisotropy. The A-plate has an optical axis in its in-plane direction and is referred to as a positive A-plate when its optical property conditions satisfy Expression (I) below and as a negative A-plate when its optical property conditions satisfy Expression (II) below.
nx>ny=nz (I)
nx<ny=nz (II)

Furthermore, the C-plate has an optical axis in a Z-axis direction, namely, in a thickness direction and is referred to as a positive C-plate when its optical property conditions satisfy Expression (III) below and as a negative C-plate when its optical property conditions satisfy Expression (IV) below.
nx=ny<nz (III)
nx=ny>nz (IV)

In Expressions (1) to (IV) above, nx, ny and nz denote refractive indices in X-axis, Y-axis and Z-axis directions in the layer, respectively. In this case, one of the X axis and the Y axis represents an axial direction in the plane of the layer in which a maximum refractive index is obtained, while the other represents an axial direction in the plane perpendicular to the one of the X axis and the Y axis. The Z axis represents a thickness direction perpendicular to the X axis and the Y axis. In the O-plate, an optical axis direction is inclined when viewed from an in-plane direction and a Z-axis direction (thickness direction perpendicular to the in-plane direction). An optical anisotropy can be imparted by suitably applying a known method with no particular limitation, either. For example, an optically isotropic transparent film is subjected to a stretching treatment or the like so as to be provided with an optical anisotropy and thus can be used as the transparent base. Furthermore, for example, a commercially available polymer film or the like with an optical anisotropy may be purchased and used as it is as the transparent base.

The transparent base can be made of, for example, glass or a polymer film, though there is no particular limitation thereto. Although a polymer that can be used for the polymer film is not particularly limited, preferable examples of the polymer include polyester-based polymers such as polyethylene terephthalate and polyethylene naphthalate, cellulose-based polymers such as diacetylcellulose and triacetylcellulose, acrylic polymers such as polymethacrylate, styrene-based polymers such as polystyrene and an acrylonitrile-styrene copolymer (AS resin), polycarbonate-based polymers such as a bisphenol A-carbonate copolymer, straight-chain or branched polyolefins such as polyethylene, polypropylene, and an ethylene-propylene copolymer, polyolefins including cyclo-structures such as polynorbornene, vinyl chloride-based polymers, amide-based polymers such as nylon and aromatic polyamide, imide-based polymers, sulfone-based polymers, polyethersulfone-based polymers, polyether ether ketone-based polymers, polyphenylene sulfide-based polymers, vinyl alcohol-based polymers, vinylidene chloride-based polymers, vinyl butyral-based polymers, allylate-based polymers, polyoxymethylene-based polymers, and epoxy-based polymers. These polymers may be used alone or in combination of at least two types. Among the above-mentioned polymers, more preferable are cellulose-based polymers such as triacetylcellulose and the like, polycarbonate-based polymers such as a bisphenol A-carbonate copolymer and the like, polyolefins including cyclo-structures such as polynorbornene and the like, amide-based polymers such as aromatic polyamide and the like, and imide-based polymers; and particularly preferable are cellulose-based polymers.

Furthermore, the transparent base also can be made of the polymer film described in JP 2001-343529 A (WO 01/37007). As a polymer material for this, for example, a resin composition containing a thermoplastic resin with a side chain including a substituted or unsubtituted imido group and a thermoplastic resin with a side chain including substituted or unsubtituted phenyl group and cyano group can be used. Examples thereof include a resin composition having an alternating copolymer composed of isobutene and N-methyl maleimide, and an acrylonitrile-styrene copolymer. The polymer film may be formed by, for example, extruding the resin composition.

In order to increase adhesion to a liquid crystalline compound, the surface of the transparent base may be subjected to a corona discharge treatment, an ultraviolet light-ozone treatment, a saponification treatment or the like. Furthermore, one or both surfaces of the transparent base may be coated with an optically isotropic layer. Particularly, in the case where a polymer film or the like having an optical anisotropy is used as the transparent base, since the polymer film itself may have a liquid crystal alignment capability, the optically isotropic layer may be coated so that the liquid crystal alignment capability is eliminated. Furthermore, even in the case where the transparent base is optically isotropic, one or both surfaces thereof may be coated with an optically isotropic layer. The thickness of the optically isotropic layer is, for example, 0.05 to 10 μm, preferably 0.1 to 5 μm, and more preferably 0.5 to 2 μm, though there is no particular limitation thereto. The optically isotropic layer can be made of, for example, a resin layer or the like, though there is no particular limitation thereto, either. A resin that can be used is selected suitably from, for example, the same polymers that were listed as the examples of the material for the polymer film. Possibly, by coating this resin layer or the like, adhesion between the optically anisotropic layer containing a liquid crystalline compound and the transparent base also can be increased. Although a method of coating the optically isotropic layer is not particularly limited, either, for example, spin coating, roller coating, flow coating, printing, dip coating, flow-expanding, bar coating, and gravure printing can be used suitably. In this case, for example, the polymer or the like may be used in the form of a solution or a dispersion liquid. Although it is preferable to use, for example, a water dispersion liquid from the viewpoint of not being prone to cause the polymer film or the like to be corroded, a solution also may be used that uses as a solvent, for example, ketone such as methyl ethyl ketone, cyclopentanone or cyclohexanone, ester such as ethyl acetate, or hydrocarbon such as toluene.

Furthermore, although the thickness of the optically anisotropic layer containing a liquid crystalline compound is not particularly limited, it is preferable that the layer is as thin as possible in order to achieve reduction in the thickness of a retardation plate. The thickness is, for example, 0.5 to 10 μm, preferably 1 to 10 μm, and more preferably 2 to 8 μm. The alignment direction of a liquid crystalline compound in the optically anisotropic layer is not particularly limited, either, and could be set suitably so that optimum optical compensation is achieved. For example, so-called homogeneous tilt alignment, hybrid alignment, chiral nematic alignment, homogeneous horizontal alignment, homeotropic alignment and the like are preferable.

The liquid crystalline compound is not particularly limited and may be a liquid crystal monomer or a polymer. For example, as the liquid crystalline compound, rod-like liquid crystalline compounds, flat plate-like liquid crystalline compounds and polymers thereof can be used, and these compounds may be used alone or in combination of at least two types. Furthermore, in the case of using a polymer, the polymer may be a liquid crystal polymer or a liquid crystal prepolymer, and may be a homopolymer or a hetero-polymer (copolymer). Preferable examples of the liquid crystalline compound include liquid crystalline compounds of azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolans, alkenylcyclohexylbenzonitriles and polymers of these compounds. Furthermore, it is preferable that the liquid crystalline compound comprises at least one of a liquid crystal prepolymer and a liquid crystal monomer because this allows the liquid crystalline compound to be aligned at a low temperature, thereby facilitating processing. Moreover, a range of a temperature at which the liquid crystalline compound-containing layer exhibits a liquid crystal state (liquid crystal temperature range) is determined suitably depending on, for example, the type of the liquid crystalline compound. Although the liquid crystal temperature range is not particularly limited, from the viewpoint of, for example, the production and use of a retardation plate, with particular consideration given to, for example, the transparent base being deformed due to heat in the production processes, it is preferable that the temperature is not too high. The liquid crystal temperature range is, for example, 20 to 150° C., preferably 20 to 120° C., and particularly preferably 20 to 80° C. Moreover, in the liquid crystalline compound-containing layer, substances other than the liquid crystalline compound such as, for example, a photopolymerization initiator, a leveling agent, and a viscosity modifier may be contained suitably in an amount in such a range as not to inhibit the function of a retardation plate.

There is no particular limitation to the alignment substrate, either, and as the alignment substrate, for example, a stretched polymer film made from polyethylene terephthalate or the like, a triacetylcellulose film or the like that is subjected directly to a rubbing treatment, and a base on which an alignment film having a liquid crystal alignment capability is provided can be used preferably. There is no particular limitation to the alignment film, either. For example, the alignment film may have been subjected to a rubbing treatment so as to be provided with a liquid crystal alignment capability, or alternatively, depending on the type thereof, the alignment film also may have been subjected to light irradiation or the like instead of a rubbing treatment so as to be provided with a liquid crystal alignment capability. Furthermore, in the case of forming an alignment substrate by applying a solution for forming an alignment film on a polymer film, it is preferable that a solvent in the solution and the polymer film are selected suitably so that the polymer film is prevented from being corroded by the solvent.

Based on the respective surface states of the alignment substrate and the transparent base and the type of the liquid crystalline compound, the alignment direction of the liquid crystalline compound can be controlled in accordance with the same law as in the conventional methods. For example, a nematic liquid crystalline compound of a certain type is applied to a transparent base without a liquid crystal alignment capability, and the compound is allowed to be aligned using an uniaxially stretched polyethylene terephthalate film as an alignment substrate, resulting in an alignment state of, for example, homogeneous alignment (homogeneous horizontal alignment) in which the compound is aligned along a stretching direction.

When trying to obtain an optically anisotropic layer having the property of, for example, the O-plate, namely, an optically anisotropic layer having a so-called tilt angle, it is preferable that the alignment substrate has a liquid crystal tilt alignment capability. Although there is no particular limitation to the alignment substrate having the liquid crystal tilt alignment capability, examples thereof include alignment substrates respectively including an oblique evaporation film, an optical alignment film, a rubbing film and the like. Each of these films is formed suitably on a base made of glass, a polymer film or the like, and thus the alignment substrate having the liquid crystal tilt alignment capability can be obtained. Among the examples of the alignment substrate, the alignment substrate including an optical alignment film or the alignment substrate including a rubbing film are preferable because, for example, these substrates can be produced without using a high-temperature process that causes damage to the base. Although a material for the alignment substrate having the liquid crystal tilt alignment capability is not particularly limited, either, for example, an alignment substrate containing long-chain alkyl polyimide or an alignment substrate containing polysiloxane is used preferably. These substrates may be formed of, for example, the base on which a rubbing film made from long-chain alkyl polyimide or a rubbing film made from polysiloxane is provided. Alternatively, an alignment film also may be used that is obtained by rubbing the base, which itself is formed from long-chain alkyl polyimide. A method of producing the alignment substrates having the liquid crystal tilt alignment capability is not particularly limited, either, and for example, any conventional method could be applied suitably thereto. For example, an oblique evaporation film is described in JP 5(1993)-11252 A, and a rubbing film made from polysiloxane is described in JP 5(1993)-53016 A.

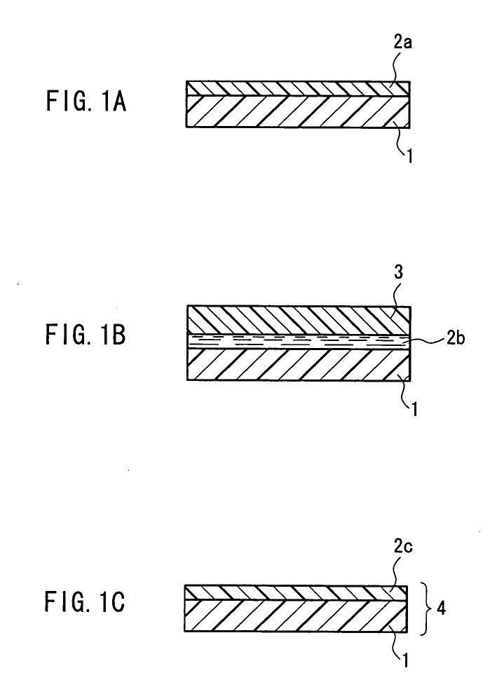

The description is directed to an example of the production method according to the present invention based on process steps shown in FIG. 1. That is, first, as shown in FIG. 1A, a liquid crystalline compound-containing layer 2a that is a precursor of an optically anisotropic layer is formed on a transparent base 1. Although a method of forming the layer 2a is not particularly limited, preferable examples of the method include a method in which a solution of the liquid crystalline compound is applied to the transparent base 1 and dried or a method in which a melt of the liquid crystalline compound is applied to the transparent base 1. In the present invention, a “melt” of a liquid crystalline compound refers to the liquid crystalline compound in a liquid crystal state or a liquid state.

Furthermore, in the case where one or both surfaces of the transparent base 1 is coated with an optically isotropic layer, it is preferable that the liquid crystalline compound-containing layer 2a is formed on the optically isotropic layer.

In the case where the liquid crystalline compound comprises a liquid crystal prepolymer or a liquid crystal monomer, which is to be photopolymerized later, it is more preferable that a photopolymerization initiator is added thereto. Although there is no particular limitation to the photopolymerization initiator, for example, Irgacure907, Irgacure369, and Irgacure184 (trade names) produced by Ciba Specialty Chemicals and mixtures of these are used preferably. With respect to a liquid crystal prepolymer and a liquid crystal monomer, the photopolymerization initiator is added in an amount of, for example, 0.1 to 5 wt % and preferably 0.1 to 1 wt %, though there is no particular limitation thereto, either. Furthermore, in the solution of the liquid crystalline compound, there is no particular limitation to a solvent as long as the liquid crystalline compound can be dissolved in the solvent. However, in the case where the solution is applied directly on the transparent base 1, it is preferable to use a solvent that is not prone to cause the transparent base 1 to be corroded. As the solvent, for example, ketones such as methyl ethyl ketone, cyclopentanone, and cyclohexanone, esters such as ethyl acetate, and hydrocarbons such as toluene can be used.

Although a method of applying the solution or melt of the liquid crystalline compound is not particularly limited, for example, spin coating, roller coating, flow coating, printing, dip coating, flow-expanding, bar coating, and gravure printing are preferable as the method.

Next, an alignment substrate is brought into contact with the liquid crystalline compound-containing layer 2a so that the liquid crystalline compound of the layer is aligned. It is preferable that in this process, the liquid crystalline compound-containing layer 2a is heated to its liquid crystal temperature or higher, and the alignment substrate is brought into contact with the layer 2a in this state, or alternatively, the liquid crystalline compound-containing layer 2a is brought into contact with the alignment substrate, and the layer 2a in this state is heated to the liquid crystal temperature or higher. That is, for example, as shown in FIG. 1B, the liquid crystalline compound-containing layer 2a is heated to its liquid crystal temperature or higher so as to form a layer 2b in a liquid crystal state or a liquid state. In this state, an alignment substrate 3 is brought into contact with an upper portion of the layer so that the liquid crystalline compound of the layer is aligned. Alternatively, for example, the liquid crystalline compound-containing layer 2a also may be brought into contact with the alignment substrate 3 and heated in this state to the liquid crystal temperature or higher so as to form the layer 2b in the liquid crystal state or the liquid state. The liquid crystal temperature range is determined as described above. FIG. 1A illustrated the case of forming the liquid crystalline compound-containing layer 2a as a solid body. However, there is no limitation thereto, and it is preferable that the layer is formed so as to be originally in a liquid crystal state or a liquid state because this eliminates the need for performing a later process of heating. For example, an alignment substrate could be brought into contact immediately after the melt of the liquid crystalline compound is applied, or alternatively, an alignment substrate could be brought into contact immediately after the solution of the liquid crystalline compound is applied and dried at the liquid crystal temperature or higher.

The alignment substrate 3 is kept in contact with the liquid crystalline compound-containing layer 2b for, for example, 10 to 120 seconds and preferably 30 to 60 seconds, though there is no particular limitation thereto. A direction of contact of the alignment substrate 3 is not particularly limited, either, and could be set suitably depending on an objective. For example, in the case where both the transparent base 1 and the alignment substrate 3 are formed of an uniaxially stretched polymer film and the liquid crystalline compound is a nematic liquid crystalline compound, in order to obtain a proper optical compensation function, it is preferable that the respective optical axes of the transparent base 1 and the alignment substrate 3 are crossed at an appropriate angle.

Then, the alignment state of the liquid crystalline compound in the liquid crystalline compound-containing layer is fixed so as to form an optically anisotropic layer. In the case where the liquid crystalline compound comprises at least one of a liquid crystal prepolymer and a liquid crystal monomer, it is preferable that the alignment state is fixed by photopolymerization of the liquid crystalline compound. Although there is no particular limitation to light to be irradiated in this case, for example, ultraviolet light is used preferably. The ultraviolet light more preferably has a wavelength of 200 to 400 nm. The light intensity, irradiation time and integrated optical power of the light to be irradiated are not particularly limited as long as they are respectively at such certain levels as to allow the alignment state to be fixed sufficiently. Furthermore, a direction of irradiation of the light to be irradiated is not particularly limited, either, as long as the irradiation onto the liquid crystalline compound-containing layer is not hindered, and the light may be irradiated from either of a transparent base side or an alignment substrate side.

Furthermore, in the case where the liquid crystalline compound is a liquid crystal polymer, it is preferable that the alignment state is fixed by cooling of the liquid crystalline compound-containing layer to a temperature lower than its liquid crystal temperature. A method of cooling is not particularly limited, and the liquid crystalline compound-containing layer may be simply left to stand under a condition of room temperature, or alternatively, also may be cooled rapidly using a proper cooler.

Then, as shown in FIG. 1C, the alignment substrate 3 is removed, and thus a retardation plate 4 composed of the transparent base 1 and an optically anisotropic layer 2c is produced.

The production method according to the present invention can be performed in the above-described manner. However, the foregoing description merely represents one embodiment of the present invention, and various changes can be made in the invention without departing from the scope thereof. For example, process steps other than the above-described process steps (1) to (4) may be included suitably.

As has often been the case in conventional methods, the liquid crystalline compound is photopolymerized in an environment such as under a nitrogen-purge atmosphere or the like. The reason for this is that, in many cases, photopolymerization is performed as radical polymerization, and oxygen in the air may inhibit polymerization (curing), causing an optically anisotropic layer to have insufficient hardness, durability and the like. However, in the case of performing photopolymerization by the production method according to the present invention, light irradiation is performed in a state where the liquid crystalline compound-containing layer is sandwiched between the transparent base and the alignment substrate, and thus necessarily, photopolymerization is performed in a state where the liquid crystalline compound hardly is exposed to the air. This makes it easy to obtain a retardation plate having sufficient hardness, durability and the like even without performing a nitrogen-purge or the like, thereby also providing an advantage of further increasing the efficiency in producing a retardation plate.

The description is directed next to still another embodiment of the production method according to the present invention. However, this embodiment also should be considered as merely illustrative, and the present invention is not limited thereto.

In the production method according to the present invention, from the view points of, for example, further increasing the efficiency of production on an industrial scale, it is preferable that the transparent base is a transfer band-like transparent base, and the above-described process steps (1) to (4) are performed continuously at the same time that feeding of the transparent base is performed continuously. Further, it is preferable that the alignment substrate is a transfer band-like alignment substrate, and the above-described process steps (2) to (4) are performed continuously at the same time that feeding of the alignment substrate is performed continuously. In this case, it is more preferable that at least one of the transparent base and the alignment substrate is fed out using a roller. Further, it is more preferable that a process step (5) of winding up the retardation plate further is included. There is no particular limitation to a specific method of performing such a production method, and the production method can be performed by suitably applying a conventionally known so-called roll-to-roll process or the like. The following describes an example of the specific method.

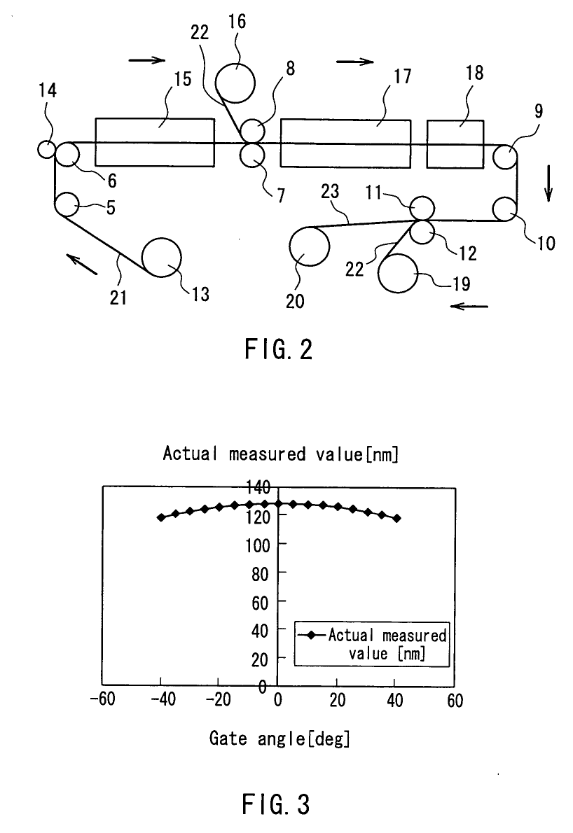

FIG. 2 schematically shows an example of a device for performing the production method according to the present invention. However, the figure should be considered as merely illustrative and in no way limits the present invention thereto. As shown in the figure, this device includes as main components, rollers 5 to 12, a transparent base supplying roll 13, a liquid crystalline compound solution applying unit 14, a drying unit 15, an alignment substrate supplying roll 16, a heating unit 17, a liquid crystal alignment fixing unit 18, an alignment substrate winding-up unit 19, and a retardation plate winding-up unit 20. Among the rollers 5 to 12, the rollers 5, 9 and 10 are guide rolls, the roller 6 is an applying roll, the rollers 7 and 8 are a pair of opposed laminator rolls, and the rollers 11 and 12 are a pair of opposed rollers. Although a material of the rollers 5 to 12 is not particularly limited, as the material, for example, metal such as stainless steel, rubber, silicone, or the like can be used suitably. It is preferable that the rollers 5 to 12 have a surface as smooth as possible. Furthermore, the rollers 5 to 12 may be connected to a temperature controlling unit as required so as to be at a varying temperature. As the liquid crystalline compound solution applying unit 14, for example, a unit including an applying member such as a coater or the like can be used, though there is no particular limitation thereto. Although the coater is not particularly limited, either, for example, in view of a physical property or the like of a liquid crystalline compound solution to be used, a gravure coater, a wire-bar coater, and a die coater can be used suitably. As the liquid crystal alignment fixing unit 18, for example, a cooling unit, a light irradiation unit or the like can be used suitably according to the type of a liquid crystalline compound to be used. The relationship between the type of a liquid crystalline compound and a method of fixing an alignment state is as described above. There is no particular limitation as to a light source of the light irradiation unit, and, for example, a known ultraviolet lamp can be used suitably. On the transparent base supplying roll 13 and the alignment substrate supplying roll 16, a transfer band-like transparent base 21 and a transfer band-like alignment substrate 22 are wound in a rolled-state, respectively, and the transparent base supplying roll 13 and the alignment substrate supplying roll 16 are arranged so that continuous feeding of the transparent base 21 and the alignment substrate 22 can be performed by means of the rollers 5 to 12. In the figure, arrows indicate directions in which the transparent base 21 and the alignment substrate 22 are fed out.

A method of producing a retardation plate using the device shown in FIG. 2 can be performed, for example, in the following manner. That is, first, the transparent base 21 is fed out from the transparent base supplying roll 13, runs over the guide roll 5, and is passed through between the applying roll 6 and the liquid crystalline compound solution applying unit 14. Then, at this point, a liquid crystalline compound solution is applied on an upper surface of the transparent base 21 by the liquid crystalline compound solution applying unit 14. The applied liquid crystalline compound solution further is dried by the drying unit 15, and thus a liquid crystalline compound-containing layer is formed on the transparent base 21. The transparent base 21 with the liquid crystalline compound-containing layer formed thereon and the alignment substrate 22 that has been fed out from the alignment substrate supplying roll 16 are sandwiched by the laminator rolls 7 and 8 so that the upper surface of the transparent base 21 (surface on which the liquid crystalline compound-containing layer is applied) is bonded to the alignment substrate 22. It is preferable that at this time, the liquid crystalline compound-containing layer is in a liquid state (isotropic state) or a liquid crystal state because this facilitates adhesion to the alignment substrate 22, though there is no particular limitation thereto. After forming the liquid crystalline compound-containing layer, viscosity may be controlled so as to obtain further increased adhesion to the alignment substrate 22. This controlling can be performed by suitably using a known method such as, for example, a method using an infrared heater (not shown) or a method in which hot air is applied, though there is no particular limitation thereto. Next, the transparent base 21 to which the alignment substrate 22 is bonded with the liquid crystalline compound-containing layer interposed therebetween further is fed out to be passed though an inner portion of the heating unit 17, in which heating is performed so that the liquid crystalline compound-containing layer is liquefied, and further is fed out to be passed through an inner portion of the liquid crystal alignment fixing unit 18. There is no particular limitation to a temperature at which the heating is performed in the inner portion of the heating device 17 and could be selected suitably according to, for example, the type of the liquid crystalline compound. During this time, the liquid crystalline compound is allowed to be aligned, and moreover, the alignment state is fixed in the inner portion of the liquid crystal alignment fixing unit 18, and thus an optically anisotropic layer is formed. As described above, the alignment state is fixed by a method that varies depending on the type of a liquid crystalline compound. In the case where the liquid crystalline compound is a liquid crystal polymer (non-photoactive compound), a method can be used in which an alignment state of the liquid crystalline compound is kept and fixed (vitrified) in that state by cooling. This cooling is performed by, for example, rapid cooling using cold air or simple exposure under an environment of room temperature, though there is no particular limitation thereto. In the case where the liquid crystalline compound is a liquid crystal monomer or a liquid crystal prepolymer (photoactive compound), a state can be fixed by photopolymerization (photocuring). An amount of light to be irradiated is not particularly limited as long as it is such an amount as to allow the liquid crystalline compound to be cured sufficiently. As described above, this photopolymerization is efficient because it makes it easy to obtain a retardation plate having sufficient hardness, durability and the like even without performing a nitrogen-purge or the like. Then, after being passed through the liquid crystal alignment fixing unit 18, the transparent base 21 on which the optically anisotropic layer is formed further is fed out, runs over the guide roll 9 and then over the guide roll 10, and is passed through between the rollers 11 and 12. During the time of this passing, the alignment substrate 22 is removed by peeling from the transparent base 21 by the alignment substrate winding-up unit 19 so as to obtain a desired retardation plate 23. The retardation plate 23 further is wound up by the retardation plate winding-up unit 20. The method of producing a retardation plate using the device shown in FIG. 2 can be performed as described above.

According to the above-described embodiment, by regularly and continuously performing the process steps from the step of feeding out a transparent base to the step of winding up a completed retardation plate, high efficiency in producing a retardation plate can be achieved, thereby enabling mass production. Moreover, compared with the case where the respective process steps are performed separately and non-continuously, an advantage also is provided that it is made easier to prevent the formation of wrinkles and adherence of dust resulting from preservation of goods during the course of production and the increase in the number of working process steps.

A retardation plate produced by the production method according to the present invention is thin and highly functional and has no appearance defect. The retardation plate can be used widely in various optical elements, liquid crystal display elements and the like with no particular limitation.

An optical element according to the present invention is an optical element including the retardation plate of the present invention and a polarizer. It is preferable that the optical element further includes a transparent protective film, and the transparent protective film is arranged between the retardation plate and the polarizer. For example, the retardation plate of the present invention further is laminated on a polarizing plate formed of a polarizer on which a transparent protective film is laminated, and thus the optical element according to the present invention can be obtained. Furthermore, in the optical element according to the present invention, an arbitrary component other than these components, i.e. the polarizer and the transparent protective film may be included suitably. The following specifically describes the components of the optical element according to the present invention.

Although there is no particular limitation to the polarizer, it is preferable that a stretched film is used as the polarizer because it makes it easier to obtain an excellent optical property. For example, the polarizer can be a film prepared by a conventionally known method of, for example, dyeing by allowing films of various types to adsorb a dichroic material such as iodine or a dichroic dye, followed by crosslinking, stretching and drying. Especially, films that transmit linearly polarized light when natural light is made to enter those films are preferable, and films having excellent light transmittance and polarization degree are preferable. Examples of the film of various types in which the dichroic material is to be adsorbed include hydrophilic polymer films such as polyvinyl alcohol (PVA)-based films, partially-formalized PVA-based films, partially-saponified films based on ethylene-vinyl acetate copolymer, and cellulose-based films. Other than the above, polyene aligned films such as dehydrated PVA and dehydrochlorinated polyvinyl chloride can be used, for example. Among them, the polyvinyl alcohol-based polarizing films are preferable because they make it easier to obtain an excellent optical property. Furthermore, the thickness of the polarizer is, for example, in a range of 1 to 80 μm, though there is no particular limitation thereto.

There is no particular limitation to the transparent protective film, and any conventionally known transparent film can be used as the transparent protective film. For example, films that are excellent in transparency, mechanical strength, thermal stability, water-shielding property, isotropy and the like are preferable. Specific examples of a material for such a transparent protective film include polyester-based polymers such as polyethylene terephthalate and polyethylene naphthalate, cellulose-based polymers such as diacetylcellulose and triacetylcellulose, acrylic polymers such as polymethacrylate, styrene-based polymers such as polystyrene and an acrylonitrile-styrene copolymer (AS resin), polycarbonate-based polymers such as a bisphenol A-carbonate copolymer, straight-chain or branched polyolefins such as polyethylene, polypropylene, and an ethylene-propylene copolymer, polyolefins including cyclo-structures such as polynorbornene, vinyl chloride-based polymers, amide-based polymers such as nylon and aromatic polyamide, imide-based polymers, sulfone-based polymers, polyethersulfone-based polymers, polyether ether ketone-based polymers, polyphenylene sulfide-based polymers, vinyl alchol-based polymers, vinylidene chloride-based polymers, vinyl butyral-based polymers, allylate-based polymers, polyoxymethylene-based polymers, and epoxy-based polymers. Moreover, for example, thermosetting resins or ultraviolet curable resins based on acrylic substances, urethane, acrylic urethane, epoxy, silicone and the like also can be used. These materials may be used alone or in combination of at least two types. Among these, from the aspects of a polarization property and durability, a TAC film having a surface saponified with alkali or the like is preferable. Other than these, for example, the polymer film described in JP 2001-343529 A (WO 01/37007) also can be used preferably.

Furthermore, it is preferable that the transparent protective film is, for example, colorless. Specifically, a retardation value (Rth) in a thickness direction of the film is, preferably in a range of −90 nm to +75 nm, more preferably in a range of −80 nm to +60 nm, and particularly preferably in a range of −70 nm to +45 nm. With the retardation value in the range of −90 nm to +75 nm, coloring (optical coloring) ascribable to the protective film can be solved sufficiently. In this case, Rth should be expressed by Expression (V) below. In the expression below, nx, ny and nz denote the same as those defined for Expressions (I) to (IV) above, and d denotes the thickness of the transparent protective film.
Rth=[{(nx+ny)/2}−nz]×d (V)

The thickness of the transparent protective film is not particularly limited and can be determined suitably according to, for example, a phase difference, protection strength or the like. Generally, the thickness is in a range of not more than 500 μm, preferably of 5 to 300 μm, and more preferably of 5 to 150 μm.

The transparent protective film can be formed suitably by any conventionally known method such as, for example, a method in which any of the above-mentioned various types of transparent resins is applied to a polarizer or a method in which a film made of any of the above-mentioned transparent resins is laminated on the polarizer. Furthermore, a commercially available transparent protective film also can be used. Furthermore, a transparent base in the retardation plate of the present invention may be used so as to function also as the transparent protective film.

Furthermore, the transparent protective film may have been subjected further to, for example, a hard coating treatment, an antireflection treatment, treatments for anti-sticking, diffusion and anti-glare and the like. The hard coating treatment is intended, for example, to prevent scratches on a surface and is a treatment of, for example, forming a coating film of a curable resin with excellent hardness and smoothness on a surface of the transparent protective film. The curable resin can be selected from, for example, ultraviolet curable resins based on silicone, urethane, acrylic substances, and epoxy. The treatment can be performed by any conventionally known method. The anti-sticking is intended to prevent sticking with adjacent layers. The antireflection treatment is intended to prevent reflection of external light on a surface of a polarizing plate and can be performed by forming a conventionally known anti-reflection film or the like.

The anti-glare treatment is intended to prevent reflection of external light from hindering visibility of transmitted light. The anti-glare treatment can be performed in a manner in which a microscopic asperity is formed on the surface of the transparent protective film by any conventionally known method. Such an asperity can be formed by, for example, roughening the surface by sand-blasting, embossing or the like, or forming the transparent protective film by blending transparent fine particles into any of the above-mentioned transparent resins.

The above-described transparent fine particles can be selected from silica, alumina, titania, zirconia, stannic oxide, indium oxide, cadmium oxide, antimony oxide and the like. Other than these, for example, inorganic fine particles having electroconductivity, organic fine particles formed of, for example, crosslinked or uncrosslinked polymer particles also can be used. An average diameter of the transparent fine particles is, for example, in a range of 0.5 to 20 μm, through there is no particular limitation thereto. Generally, with respect to 100 weight parts of any of the above-mentioned transparent resins, the transparent fine particles are blended in an amount, preferably in a range of 2 to 70 weight parts, and more preferably in a range of 5 to 50 weight parts, though there is no particular limitation thereto.

An anti-glare layer into which the transparent fine particles are blended also can be used as, for example, a transparent protective film itself, or alternatively, also may be formed on a surface of a transparent protective film as a coating layer or the like. Moreover, the anti-glare layer also may function as a diffusion layer to diffuse transmitted light so as to obtain enlarged visual angles (visually-compensating function or the like).

The antireflection layer, an anti-sticking layer, the diffusion layer, the anti-glare layer and the like also may be laminated on a polarizing plate as, for example, an optical layer formed of a sheet or the like including these layers, separately from the transparent protective film.

Furthermore, the polarizing plate further may include other conventionally known optical layers of various types used for forming a liquid crystal display or the like such as, for example, a reflector, a semitransparent reflector, and a brightness-enhancement film. These optical layers may be used alone or in a combination of at least two types. Furthermore, each of the optical layers may be laminated as a monolayer or in at least two layers. The following describes such an integrated polarizing plate.

First, an example of a reflective polarizing plate or a semitransparent reflective polarizing plate will be described. The reflective polarizing plate is formed by further laminating a reflector on the polarizer and the transparent protective film, and the semitransparent reflective polarizing plate is formed by laminating a semitransparent reflector on the polarizer and the transparent protective film.

For example, the reflective polarizing plate is arranged on a backside of a liquid crystal cell and used in a liquid crystal display that reflects incident light from a visible side (display side) (a reflective liquid crystal display). The reflective polarizing plate has some merits, for example, assembling of light sources such as backlight can be omitted, and the liquid crystal display can be thinned further.

The reflective polarizing plate can be formed by any conventionally known method such as a method in which a reflector of metal or the like is formed on one surface of a polarizing plate having an elastic modulus. Specifically, for example, a transparent protective film of the polarizing plate is treated by matting one surface (exposed surface) if required. On the surface, foil formed of a reflective metal such as aluminum or a deposition film is formed as a reflector, and thus a reflective polarizing plate is obtained.

Furthermore, other examples include a reflective polarizing plate formed in the following manner. That is, on the above-described transparent protective film that is formed by allowing fine particles to be contained in any of various transparent resins and thus has a surface of a microscopic asperity, a reflector corresponding to the microscopic asperity is formed. The reflector having a microscopic asperity surface diffuses incident light by irregular reflection so that directivity and glare can be prevented and irregularity in color tones can be controlled. This reflector can be formed by disposing metal foil or a metal deposition film directly on a microscopic asperity surface of the transparent protective film by any of conventionally known methods including deposition and plating such as vacuum deposition, ion plating, sputtering and the like.

Furthermore, as an alternative to the above-described reflector formed directly on a transparent protective film of a polarizing plate, for example, a reflecting sheet formed by providing a reflecting layer on a suitable film such as the transparent protective film may be used as a reflector. Since the reflecting layer of the reflector typically is made of metal, it is preferable in use of the reflector that a reflecting surface of the reflecting layer is coated with the film, a polarizing plate or the like from the aspects of, for example, preventing the reflection rate from lowering due to oxidation, thereby maintaining the initial reflection rate for a long time and eliminating the need to form a separate transparent protective film.

Meanwhile, the semitransparent polarizing plate is provided by replacing the reflector in the above-described reflective polarizing plate by a semitransparent reflector, and it is exemplified by a half mirror that reflects and transmits light at a reflecting layer.

For example, the semitransparent polarizing plate is arranged on a backside of a liquid crystal cell. In a liquid crystal display comprising the semitransparent polarizing plate, incident light from the visible side (display side) is reflected to display an image when the liquid crystal display is used in a relatively bright atmosphere, while in a relatively dark atmosphere, an image is displayed by using a built-in light source such as a backlight in the backside of the semitransparent polarizing plate. In other words, the semitransparent polarizing plate can be used to form a liquid crystal display that can save energy for a light source such as a backlight under a bright atmosphere, while the built-in light source can be used under a relatively dark atmosphere.

Now, an example of a polarizing plate obtained by further laminating the polarizer and the transparent protective film with a brightness enhancement film will be described.

The brightness enhancement film is not particularly limited but can be a film having a property of transmitting linearly polarized light with a predetermined polarization axis and reflecting other light, for example, a dielectric multilayer thin film or a multilayer laminate of thin films with different refractive index anisotropies. Such a brightness enhancement film is, for example, trade name “D-BEF” produced by 3M Corporation. It also is possible to use a cholesteric liquid crystal layer, especially an aligned film of a cholesteric liquid crystal polymer, and this aligned liquid crystal layer supported on a film base. These films exhibit a property of reflecting one of right and left circularly polarized lights and transmitting the other light and are, for example, trade name “PCF350” produced by Nitto Denko Corporation or trade name “Transmax” produced by Merck Ltd.

Although the optical element according to the present invention may be formed simply by laminating the components (a retardation plate, a polarizer, a transparent protective film and the like), it is preferable that, for example, at least one adhesive layer further is included, and all or part of the components are laminated with the adhesive layer interposed between two of the components. Such an optical element can be produced by any conventionally known method with no particular limitation. For example, the optical element can be produced by a method in which a pressure-sensitive adhesive, an adhesive or the like is applied to each of the components so that an adhesive layer is formed, and the components are attached to each other via the adhesive layer. For example, first, the retardation plate of the present invention and a polarizer to which a transparent protective film is bonded are prepared. Next, an adhesive is applied on one surface of either of the retardation plate and the transparent protective film, and further, the retardation plate is attached onto the transparent protective film, and thus a desired optical element can be produced. There is no particular limitation to the type of the pressure-sensitive adhesive or the adhesive and can be selected suitably depending on, for example, materials for the components. Examples thereof include polymeric adhesives based on acrylic substances, vinyl alcohol, silicone, polyester, polyurethane, polyether and the like, and rubber-based adhesives. Although there is no clear distinction between the “adhesive” and the “pressure-sensitive adhesive” in the present invention, among the other adhesives, an adhesive that allows bonded objects to peel off from each other or re-bond to each other relatively easily is referred to as the “pressure-sensitive adhesive. The pressure-sensitive adhesive and the adhesive mentioned above do not peel off easily even when being exposed to moisture or heat, for example, and have excellent light transmittance and polarization degree. Specifically, these pressure-sensitive adhesive and adhesive preferably are PVA-based adhesives when the polarizer is a PVA-based film from the aspect of, for example, stability of a bonding treatment. These adhesive and pressure-sensitive adhesive may be applied directly to surfaces of the polarizer and the transparent protective film, or a layer of a tape or a sheet formed of the adhesive or pressure-sensitive adhesive may be arranged on the surfaces thereof. Further, when these adhesive and pressure-sensitive adhesive are prepared as an aqueous solution, for example, other additives or a catalyst such as an acid catalyst may be blended as necessary. In the case of applying the adhesive, other additives or a catalyst such as an acid catalyst further may be blended in the aqueous solution of the adhesive. The thickness of the adhesive layer is not particularly limited but may be, for example, 1 nm to 500 nm, preferably 10 nm to 300 nm, and more preferably 20 nm to 100 nm.

Each of the polarizer, the transparent protective film, the optical layer, the pressure-sensitive adhesive layer and the like that form the optical element of the present invention as described above may be treated suitably with an UV absorber such as salicylate ester-based compounds, benzophenone-based compounds, benzotriazole-based compounds, cyanoacrylate-based compounds, or nickel complex salt-based compounds, thus providing an UV absorbing capability.

The optical element of the present invention also can be produced by laminating each component on a liquid crystal cell surface or the like in sequence in each production process of a liquid crystal display, for example. However, it is more preferable to prepare an optical element of the present invention by the lamination of the individual components and use it for producing the liquid crystal display because there is an advantage in that excellent quality stability and assembling operability are achieved, leading to an improvement in the efficiency in producing a liquid crystal display.

It is preferable that the optical element of the present invention further has the pressure-sensitive adhesive layer or the adhesive layer described above on one or both of its outer surfaces because easier lamination onto other members such as a liquid crystal cell can be achieved. The pressure-sensitive adhesive layer or the like can be a monolayer or a laminate. The laminate can include monolayers different from each other in the compositions or in the types. When arranged on both surfaces of the optical element, the pressure-sensitive adhesive layers can be the same or can be different from each other in compositions or types. In the case where a surface of the pressure-sensitive adhesive layer or the like provided on the optical element is exposed, it is preferable to cover the above-noted surface with a separator so as to prevent contamination until the pressure-sensitive adhesive layer or the like is put to use. The separator can be made by coating a suitable film with a peeling coat of a peeling agent such as a silicone-based agent, a long-chain alkyl-based agent, a fluorine-based agent, an agent comprising molybdenum sulfide or the like as necessary. The material for the film is not particularly limited but can be similar to that for the transparent protective film, for example.

There is no particular limitation on how to use the optical element of the present invention. However, the optical element is suitable for use in various image display apparatuses, for example, being arranged on the surface of a liquid crystal cell.

The description is directed next to an image display apparatus according to the present invention. The image display apparatus according to the present invention is an image display apparatus including the retardation plate of the present invention or the optical element of the present invention. Other than the above, there is no particular limitation to the image display apparatus according to the present invention. Its production method, configuration, use or the like can be selected arbitrarily, and any conventionally known mode can be applied suitably thereto.

The type of the image display apparatus of the present invention is not particularly limited but preferably is a liquid crystal display. For example, it is possible to arrange the retardation plate or the optical element of the present invention on one surface or both surfaces of a liquid crystal cell so as to form a liquid crystal panel and to use it in a reflection-type, semi-transmission-type or transmission and reflection type liquid crystal display. The type of the liquid crystal cell forming the liquid crystal display can be selected arbitrarily. For example, it is possible to use any type of liquid crystal cells such as an active-matrix driving type represented by a thin-film transistor type, or a simple-matrix driving type represented by a twisted nematic type or a super twisted nematic type.

The liquid crystal cell is typically composed of opposing liquid crystal cell substrates and a liquid crystal injected into a space between the substrates. The liquid crystal cell substrates can be made of glass, plastics or the like without any particular limitations. Materials for the plastic substrates can be selected from conventionally known materials without any particular limitations.

Furthermore, the optical element according to the present invention may be provided on one surface or both surfaces of a liquid crystal cell. In the case where a member such as the optical element is provided on each surface of a liquid crystal cell, the optical elements may be of the same type or different types. Moreover, in producing a liquid crystal display, for example, a suitable component such as a prism array sheet, a lens array sheet, a light diffusion plate or a backlight can be arranged in one or at least two layers at an appropriate position.

The structure of the liquid crystal panel in the liquid crystal display according to the present invention is not particularly limited. However, it is preferable that a liquid crystal cell, the retardation plate of the present invention, a polarizer and a transparent protective film are included, for example, and the retardation plate, the polarizer and the transparent protective film are laminated in this order on one surface of the liquid crystal cell. For the retardation plate of the present invention, the optically anisotropic layer side can face the liquid crystal cell, while the transparent base side can face the polarizer, for example, though there is no particular limitation on their arrangement.

In the case where the liquid crystal display of the present invention further includes a light source, the light source preferably is a flat light source emitting polarized light so as to use light energy effectively, though there is no particular limitation.

Moreover, the image display apparatus according to the present invention is not limited to the liquid crystal display described above and may be a self-light-emitting display such as an organic electroluminescence (EL) display, a plasma display (PD) or an FED (field emission display). When used in a self-light-emitting flat display, the retardation plate of the present invention can be utilized as an antireflection filter because it can obtain circularly polarized light by setting an in-plane retardation value of its optically anisotropic layer to be λ/4.

The following is a description of an electroluminescence (EL) display according to the present invention. The EL display of the present invention has the retardation plate or the optical element of the present invention and may be either an organic EL display or an inorganic EL display.

In recent years, for EL displays, it has been suggested to use an optical film such as a polarizer or a polarizing plate together with a λ/4 plate for preventing reflection from an electrode in a black state. The retardation plate and the optical element of the present invention are very useful particularly when any of linearly polarized light, circularly polarized light and elliptically polarized light is emitted from the EL layer, or when obliquely emitted light is polarized partially even if natural light is emitted in the front direction.

The following description is directed to a typical organic EL display. In general, the organic EL display has a luminant (organic EL ruminant) that is prepared by laminating a transparent electrode (an anode), an organic ruminant layer and a metal electrode (a cathode) in this order on a transparent substrate. Here, the organic ruminant layer is a laminate of various organic thin films. Known examples thereof include a laminate of a hole injection layer made of a triphenylamine derivative or the like and a luminant layer made of a fluorescent organic solid such as anthracene; a laminate of the luminant layer and an electron injection layer made of a perylene derivative or the like; or a laminate of the hole injection layer, the luminant layer and the electron injection layer.

The organic EL display emits light on the following principle: a voltage is applied to the anode and the cathode so as to inject holes and electrons into the organic ruminant layer, and re-bonding of these holes and electrons generates energy. Then, this energy excites the fluorescent substance, which emits light when it returns to the basis state. The mechanism of the re-bonding is similar to that of an ordinary diode. This implies that current and the light emitting intensity exhibit a considerable nonlinearity accompanied with a rectification with respect to the applied voltage.

It is necessary for the organic EL display that at least one of the electrodes is transparent so as to obtain luminescence at the organic ruminant layer. In general, a transparent electrode of a transparent conductive material such as indium tin oxide (ITO) is used for the anode. Use of substances having small work function for the cathode is important for facilitating the electron injection and thereby raising luminous efficiency, and in general, metal electrodes such as Mg—Ag, and Al—Li may be used.

In an organic EL display configured as described above, it is preferable that the organic luminant layer is made of a film that is extremely thin such as about 10 nm. Therefore, the organic luminant layer can transmit substantially whole light as the transparent electrode does. As a result, when the layer does not illuminate, a light beam entering from the surface of the transparent substrate and passing through the transparent electrode and the organic ruminant layer before being reflected at the metal layer comes out again to the surface of the transparent substrate. Thereby, the display surface of the organic EL display looks like a mirror when viewed from the outside.

The organic EL display according to the present invention preferably includes, for example, the retardation plate or the optical element of the present invention on the surface of the transparent electrode. With this configuration, the organic EL display has an effect of suppressing external reflection and improving visibility or the like. For example, the optical element of the present invention including the retardation plate and the polarizing plate functions to polarize light which enters from outside and is reflected by the metal electrode, and thus the polarization has an effect that the mirror of the metal electrode cannot be viewed from the outside. Particularly, the mirror of the metal electrode can be blocked completely by forming the retardation plate of the present invention with a quarter wavelength plate and adjusting an angle formed by the polarization directions of the polarizing plate and the retardation plate to be π/4. That is, the polarizing plate transmits only the linearly polarized light component among the external light entering the organic EL display. In general, the linearly polarized light is changed into elliptically polarized light by the retardation plate. However, when the retardation plate is a quarter wavelength plate and when the above-noted angle is π/4, the light is changed into circularly polarized light.

For example, this circularly polarized light passes through the transparent substrate, the transparent electrode, and the organic thin film. After being reflected by the metal electrode, the light passes again through the organic thin film, the transparent electrode and the transparent substrate, and turns back into linearly polarized light at the retardation plate. Moreover, since the linearly polarized light crosses the polarization direction of the polarizing plate at a right angle, it cannot pass through the polarizing plate. As a result, the mirror of the metal electrode can be blocked completely as mentioned earlier.

The description is directed next to examples of the present invention. However, the present invention is not limited to the examples below.

### EXAMPLE 1

A retardation plate was produced in the following manner. That is, first, toluene was added to 1 g of an ultraviolet-polymeric nematic liquid crystalline compound (Paliocolor LC242 (trade name) produced by BASF AG) expressed by Chemical Formula (1) below and 0.05 g of a photopolymerization initiator (Irgacure907 (trade name) produced by Ciba Specialty Chemicals) and subjected to mixing for 10 minutes so that solid matter is dissolved completely, and thus a solution of a liquid crystalline compound (referred to as a coating solution A) was prepared. An amount of the toluene to be added was adjusted so that the concentration of a solute was 20 wt %. Meanwhile, a triacetylcellulose (TAC) film having a saponified surface was prepared and used as a transparent base. Moreover, another TAC film (produced by Fuji Photo Film Co., Ltd.) was prepared, and one surface thereof was subjected to a rubbing treatment so that the TAC film could be used as an alignment substrate.

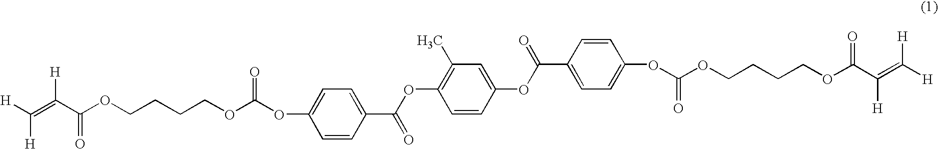

Using a bar coater, the coating solution A was applied on the transparent base and then dried by heating at 120° C. for 2 minutes, and thus a liquid crystalline compound-containing layer was formed. The layer was cooled to room temperature, and the rubbed surface of the alignment substrate was bonded to a surface of the liquid crystalline compound-containing layer at that temperature. While this bonded state was kept, heating was performed at 150° C. for 2 minutes and followed by cooling down under an environment of room temperature so that the liquid crystalline compound-containing layer was cooled to about 40° C. Moreover, ultraviolet irradiation at an integrated optical power of 200 mJ/cm² was performed with respect to the liquid crystalline compound-containing layer so that the liquid crystalline compound was polymerized, and thus an optically anisotropic layer was formed. Then, the alignment substrate was removed by peeling, and thus a desired retardation plate was produced.

### EXAMPLE 2

A retardation plate was produced in the following manner. That is, first, a coating solution A was prepared in the same manner as in Example 1. Meanwhile, a 2 wt % aqueous solution of a water dispersion type polyester resin (produced by Toyobo Co., Ltd., trade name: MD-1245) (referred to as a coating solution B) was prepared. Moreover, a triacetylcellulose (TAC) film having a saponified surface was prepared. Using a bar coater, the coating solution B was applied on one surface of the TAC film and dried by heating at 120° C. for 3 minutes so that an optically isotropic polyester resin layer was formed, and thus a transparent base was obtained. Then, another TAC film (produced by Fuji Photo Film Co.) was prepared, and one surface thereof was subjected to a rubbing treatment so that the TAC film could be used as an alignment substrate.

Next, using a bar coater, the coating solution A was applied on the polyester resin layer of the transparent base and dried by heating at 120° C. for 2 minutes, and thus a liquid crystalline compound-containing layer was formed. The layer was cooled to room temperature, and the rubbed surface of the alignment substrate was bonded to a surface of the liquid crystalline compound-containing layer at that temperature. While this bonded state was kept, heating was performed at 120° C. for 30 seconds and followed by cooling down under an environment of room temperature so that the liquid crystalline compound-containing layer was cooled to about 40° C. Moreover, ultraviolet irradiation at an integrated optical power of 200 mJ/cm² was performed with respect to the liquid crystalline compound-containing layer so that the liquid crystalline compound was polymerized, and thus an optically anisotropic layer was formed. Then, the alignment substrate was removed by peeling, and thus a desired retardation plate was produced.

### EXAMPLE 3

A retardation plate was produced in the same manner as in Example 1 except that as a transparent base, a glass plate was used instead of a TAC film.

### EXAMPLE 4

A retardation plate was produced in the same manner as in Example 1 except that as an alignment substrate, a uniaxially stretched polyethylene terephthalate (PET) film was used instead of a TAC film subjected to a rubbing treatment.

### COMPARATIVE EXAMPLE 1

A retardation plate was produced in the following manner. That is, first, a coating solution A was prepared in the same manner as in Examples 1 and 2. Meanwhile, a coating solution B was prepared in the same manner as in Example 2. Moreover, a glass substrate was prepared, and using a bar coater, the coating solution B was applied on the glass substrate and dried at 120° C. for 3 minutes. Using the bar coater the coating solution A further was applied thereon and dried by heating at 120° C. for 2 minutes, and thus a liquid crystalline compound-containing layer was formed. Then, cooling-down was performed, and ultraviolet irradiation at an integrated optical power of 200 mJ/cm² was performed with respect to the liquid crystalline compound-containing layer so that the liquid crystalline compound was polymerized, and thus a desired optically anisotropic layer was produced.

(Evaluation of Liquid Crystal Alignment Property)

With respect to each of the retardation plates of Examples 1 to 4 and Comparative Example 1, an alignment state of the liquid crystalline compound was evaluated in the following manner. That is, first, two polarizing plates were prepared, and the retardation plate to be evaluated was sandwiched between the polarizing plates. The respective polarization axes of the two polarizing plates were set so as to be orthogonal to each other. Next, light was irradiated from the side of one of the polarizing plates, and it was determined whether the light was transmitted from the side of the other polarizing plate. Moreover, only the retardation plate was rotated with the polarization axes being kept in the orthogonal state. By determining the light transmission property at various angles in the same manner, the alignment state of the liquid crystalline compound was evaluated.

By the above-described evaluation, it could be determined that each of the retardation plates of Examples 1 to 4 transmitted light therethrough when its alignment axis formed an angle of 45 degrees with either of the polarization axes of the two polarizing plates. It was also determined that light was not transmitted when the alignment axis was parallel or orthogonal to either of the polarization axes. Herein, it should be noted that the “alignment axis” refers to an axis parallel to a direction of a rubbing axis of the alignment substrate in each of Examples 1 to 3 and a direction of a stretching axis of the alignment substrate in Example 4 before the alignment substrates were removed by peeling from the retardation plates.

By this evaluation, it was found that the liquid crystalline compound of each of the retardation plates of Examples 1 to 4 was aligned parallel to the alignment axis.

In contrast to this, in the above-described evaluation, the retardation plate of Comparative Example 1 transmitted light therethrough in any orientation and no extinction occurred. Moreover, a visual observation found that the retardation plate of Comparative Example 1 was clouded. Based on these, it was found that in the retardation plate of Comparative Example 1, the liquid crystalline compound was not aligned orderly.

### EXAMPLE 5

In the following manner, a retardation plate was produced by the production method according to the present invention using a roll-to-roll process.

First, a coating solution containing a liquid crystalline compound was prepared in the following manner. That is, first, toluene was added to 1 kg of an ultraviolet-polymeric nematic liquid crystalline compound expressed by Chemical Formula (1) above and 50 g of a photopolymerization initiator (Irgacure907 (trade name) produced by Ciba Specialty Chemicals) and was dissolved therein, and thus a solution was prepared. An amount of the toluene was set so that the concentration of a solute was 20 wt %. The solution further was stirred for 60 minutes so that the solute was dissolved well. Moreover, the solution was filtered using a filter (produced by Nihon Pall Ltd.) having a filter diameter of 2.5 μm, and thus a desired coating solution was obtained.

Meanwhile, a transparent base was prepared. That is, first, a triacetylcellulose film that was 300 mm in width and 300 m in length was prepared. After being saponified, the film was coated with a polyester-based resin (VYLONAL MD-1245 (trade name) produced by Toyobo Co., Ltd.) and further was wound up to form a rolled raw film, and thus a desired transparent base was obtained.

Moreover, an alignment substrate was prepared. That is, first, a surface of a triacetylcellulose film that was 300 mm in width and 300 m in length was subjected to a rubbing treatment, and the film was wound up to form a rolled raw film, and thus a desired alignment substrate was obtained.

Then, a device having the structure shown in FIG. 2 was fabricated, and a desired retardation plate was produced using this device, the coating solution, the transparent base, and the alignment substrate. The production processes can be outlined as described above and are performed under the following specific conditions. That is, first, the transparent base 13 and the alignment substrate 16 were fed out at a line speed of 4 m per minute. The coating solution was used as a liquid crystalline compound solution. A micro-gravure coater was used as the liquid crystalline compound solution applying unit 14, and a wire bar No. 10 was used to control a thickness of the applied solution. Drying was performed by the drying unit 15 at 10° C., and it took one minute for a point on the transparent base 13 to enter the drying unit 15 and come out therefrom. Heating was performed at 150° C. by the heating unit 17, and it took 30 seconds for a point on each of the transparent base 13 and the alignment substrate 16 to enter the heating unit 17 and come out therefrom. A high-pressure mercury lamp having an output of 120 W/cm was used for the liquid crystal alignment fixing unit 18, and ultraviolet irradiation was performed at 600 mJ/cm².

The retardation plate 20 as a final product was transparent without clouding or the like and had an excellent light transmission property. In the same manner as in Examples 1 to 4 and Comparative Example, a liquid crystal alignment property of the retardation plate 20 was evaluated using a polarizing microscope, and as a result, the same property as that obtained in Examples 1 to 4 was observed. That is, it was determined that the retardation plate of this example had an optical anisotropy of a uniaxial alignment property. Moreover, a phase difference was measured using a spectroscopic ellipsometer (M−220 (trade name) produced by JASCO Corporation). The results are shown in FIG. 3. As shown in the figure, it was found that the retardation plate of this example had a retardation property that varies left-right symmetrically. The measurement of a phase difference was performed by using the spectroscopic ellipsometer in a conventional manner.

### EXAMPLE 6

A retardation plate having a tilt angle was produced in the following manner. That is, first, a coating solution A was prepared in the same manner as in Example 1. Meanwhile, coating solution B was prepared in the same manner as in Example 2. Moreover, a triacetylcellulose (TAC) film having a saponified surface was prepared. Using a bar coater, the coating solution B was applied on one surface of the TAC film and dried by heating at 120° C. for 2 minutes so that an optically isotropic polyester resin layer was formed, and thus a transparent base was obtained. Then, the coating solution A was applied on the polyester resin layer of the transparent base and dried by heating at 120° C. for 2 minutes, and thus a liquid crystalline compound-containing layer was formed. Meanwhile, an easily bondable polyethylene terephthalate film was prepared. A solution of a polysiloxane-based compound (COLCOAT P (trade name) produced by Colcoat Co., Ltd.) was applied on one surface of the film and was dried by heating at 120° C. for 1 minute so that a polysiloxane layer was formed. Moreover, a surface of the polysiloxane layer was subjected to rubbing so as to form an alignment film, and thus an alignment substrate having a liquid crystal tilt alignment capability was obtained. Then, the liquid crystalline compound-containing layer was bonded to the rubbed surface of the alignment film. While this state was kept, heating was performed at 120° C. for 2 minutes and followed by cooling down under an environment of room temperature so that the liquid crystalline compound-layer was cooled to about 40° C. Ultraviolet irradiation at an integrated optical power of 200 mJ/cm² was performed so that the liquid crystalline compound was polymerized, and thus an optically anisotropic layer was formed. Then, the alignment substrate was peeled off, and thus a desired retardation plate was obtained.

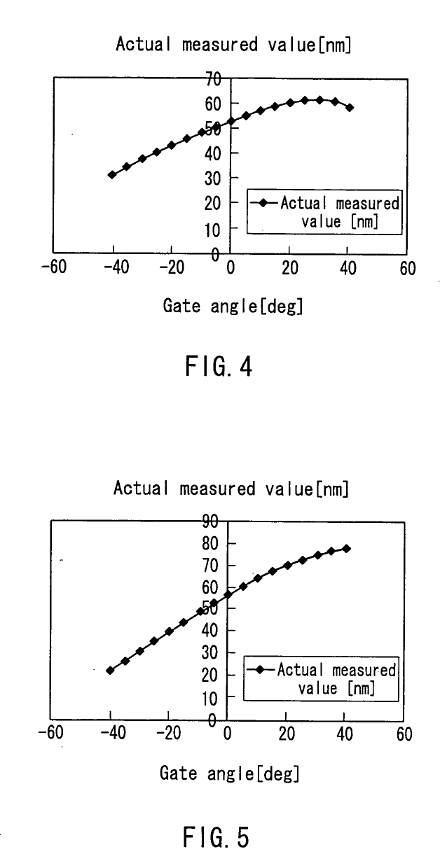

The obtained retardation plate was transparent without clouding or the like and had an excellent light transmission property. By the same method as that used in Example 5, a phase difference of the retardation plate was measured. The results are shown in FIG. 4. As shown in the figure, it was found that the retardation plate of this example exhibited a retardation property that varies left-right asymmetrically, thus having a tilt angle.

### EXAMPLE 7

A retardation plate having a tilt angle was produced in the following manner. That is, first, 20 parts by weight of a liquid crystalline copolymer compound expressed by Chemical Formula (2) below was dissolved in 80 parts by weight of dichloroethane, and thus a liquid crystalline compound solution was obtained. In Chemical Formula (2), each of n and 100−n denotes a proportion of a monomer unit (mol %), where 0≦n≦100. In the case of this example, n is 18. Furthermore, in this example, R¹ in Chemical Formula (2) denotes a hydrogen atom. This liquid crystalline copolymer compound had a weight-average molecular weight of 5000.

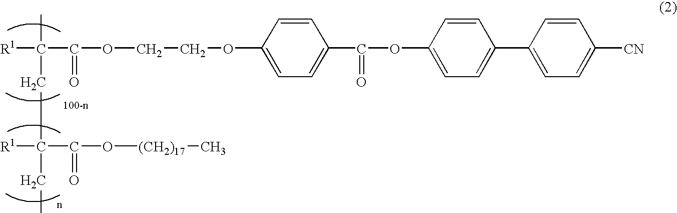

A retardation plate was produced in the same manner as in Example 6 except that this solution was used instead of the coating solution A and no ultraviolet irradiation was performed. The obtained retardation plate was transparent without clouding or the like and had an excellent light transmission property. Moreover, by the same method as that used in Examples 5 and 6, a phase difference of the retardation plate was measured. It was found that the retardation plate exhibited a retardation property that varies left-right asymmetrically, thus having a tilt angle.

### EXAMPLE 8

A retardation plate was produced in the following manner. That is, first, a 30 wt % solution of a liquid crystalline compound was obtained by dissolving an acrylic liquid crystalline compound (CB483 (trade name) produced by Vantico Inc.) in toluene. Next, a transparent base was formed in the same manner as in Example 6. The liquid crystalline compound solution was applied on a polyester layer of the transparent base and dried by heating at 120° C. for 2 minutes, and thus a liquid crystalline compound-containing layer was formed. Meanwhile, a solution for forming an optical alignment film (LPPF301 (trade name) produced by Vantico Inc.) was applied on one surface of a glass plate and dried by heating at 150° C. for 10 minutes. Moreover, irradiation with polarized ultraviolet light was performed from an oblique direction so that an alignment film was formed, and thus an alignment substrate having a liquid crystal tilt alignment capability was obtained. Then, the transparent base and the alignment substrate were attached to each other so that the liquid crystalline compound-containing layer was bonded to alignment film. While that state was kept, heating was performed at 120° C. for 2 minutes, followed by cooling down under an environment of room temperature so that the liquid crystalline compound-containing layer was cooled to about 40° C. Further, ultraviolet irradiation at an integrated optical power of 200 mJ/cm² was performed so that the liquid crystalline compound was polymerized, and thus an optically anisotropic layer was formed. Then, the alignment substrate was peeled off, and thus a desired retardation plate was obtained.

The obtained retardation plate was transparent without clouding or the like and had an excellent light transmission property. By the same method as that used in Examples 5 to 7, a phase difference of the retardation plate was measured. The results are shown in FIG. 5. As shown in the figure, it was found that the retardation plate of this example had a retardation property that varies left-right asymmetrically, thus having a tilt angle.

### COMPARATIVE EXAMPLE 2

A retardation plate was produced in the following manner. That is, first, a solution for forming an optical alignment film (LPPF301 (trade name) produced by Vantico Inc.) was applied on one surface of a glass plate and dried by heating at 150° C. for 10 minutes. Moreover, irradiation with polarized ultraviolet light was performed from an oblique direction so that an alignment film having a liquid crystal tilt alignment capability was formed, and thus a transparent base was formed. Next, in the same manner as in Example 8, a liquid crystalline compound solution was prepared, applied on the alignment film, and dried at 120° C. for 2 minutes. After that, cooling down was performed under an environment of room temperature so that the liquid crystalline compound-containing layer was cooled to about 40° C. Then, ultraviolet irradiation at an integrated optical power of 200 mJ/cm² was performed under a nitrogen-purge atmosphere so that the liquid crystalline compound was polymerized, and thus an optically anisotropic layer was formed. Thus, a desired retardation plate was obtained. This retardation plate had a tilt angle.

### COMPARATIVE EXAMPLE 3

A retardation plate was produced in the same manner as in Comparative Example 2 except that ultraviolet irradiation was performed in the ambient air and not under a nitrogen-purge atmosphere. This retardation plate had a tilt angle.

(Hardness Test and Cross-Cut Peeling Test)

Using the retardation plates of Example 8, Comparative Example 2, and Comparative Example 3, a hardness test and a cross-cut peeling test were performed with respect to an optically anisotropic layer. Using MHA-400 (trade mark) that is an instrument produced by NEC Corporation, the hardness test was performed in compliance with JIS-K5401. In the cross-cut peeling test, a pressure-sensitive adhesive tape (No. 720 (trade name) produced by Nitto Denko Corporation) was bonded to the optically anistropic layer of each of the retardation plates and peeled off, and a state of exfoliation of the optically anisotropic layer was observed.

As a result of the hardness test, in the retardation plate of Comparative Example 2 in which ultraviolet irradiation was performed with respect to the liquid crystalline compound-containing layer under a nitrogen-purge atmosphere, the optically anisotropic layer had a microhardness of 0.50 GPa. This corresponds to a pencil hardness of B. In contrast to this, in the retardation plate of Comparative Example 3 in which ultraviolet irradiation was performed in the air, the optically anisotropic layer had an insufficient microhardness of 0.20 GPa (corresponding to a pencil hardness of 4B). In the retardation plate of Example 8, despite the fact that ultraviolet irradiation was performed with respect to the liquid crystalline compound-containing layer in the air without the use of a nitrogen-purge, the optically anisotropic layer had the same microhardness as that of the retardation plate of Comparative Example 2, i.e. a microhardness of 0.50 GPa.

In the cross-cut peeling test, the retardation plate of Example 8 achieved an excellent result with almost no exfoliation occurring in the optically anisotropic layer, whereas each of Comparative Examples 2 and 3 gave a poor result with most part of the optically anisotropic layer exfoliated. That is, the retardation plate of Example 8 exhibited adhesion between the transparent base and the optically anisotropic layer that is more excellent than those of Comparative Examples 2 and 3 in each of which the optically anisotropic layer was formed on the alignment film.

### INDUSTRIAL APPLICABILITY

As described in the foregoing discussion, according to the present invention, a highly functional thin retardation plate with no appearance defect can be produced. According to the production method according to the present invention, an optically anisotropic layer containing a liquid crystalline compound may be laminated on a base without an alignment film and an adhesive interposed therebetween, and thus the method is advantageous in terms of an optical function and thickness reduction of a retardation plate. Moreover, for example, an alignment film that has been subjected to a rubbing treatment does not remain in the retardation plate, thereby causing no appearance defect attributable to the rubbing treatment. Furthermore, problems due to poor adhesion between an alignment film and the optically anisotropic layer also are eliminated. Moreover, in the case where a liquid crystalline compound is photopolymerized in the production method according to the present invention, it is made easy to obtain a retardation plate having sufficient hardness, durability and the like even without performing a nitrogen-purge or the like, and thus an advantage of further increasing efficiency in producing a retardation plate also is provided. By the application of a so-called roll-to-roll process, the production efficiency further is improved. A retardation plate produced by the production method according to the present invention can be used widely in various optical elements, image display apparatuses and the like, and can make a significant contribution particularly to thickness reduction or the like of liquid crystal displays.

1. A method of producing a retardation plate in which an optically anisotropic layer is formed on a transparent base, comprising process steps (1) to (4) below of:
(1) forming a liquid crystalline compound-containing layer on the transparent base without a liquid crystal alignment capability;
(2) bringing an alignment substrate with a liquid crystal alignment capability into contact with the liquid crystalline compound-containing layer so as to cause alignment of a liquid crystalline compound of the layer;
(3) fixing a state of the alignment of the liquid crystalline compound of the layer so that the optically anisotropic layer is formed; and
(4) removing the alignment substrate.

2. The method according to claim 1,
wherein one or both surfaces of the transparent base is coated with an optically isotropic layer, and in the process step (1), the liquid crystalline compound-containing layer is formed on the optically isotropic layer.

3. The method according to claim 1,
wherein the liquid crystalline compound comprises at least one of a liquid crystal prepolymer and a liquid crystal monomer, and in the process step (3), the state of the alignment is fixed by photopolymerization of the liquid crystalline compound.

4. The method according to claim 1,
wherein the liquid crystalline compound is a liquid crystal polymer, and in the process step (3), the state of the alignment is fixed by cooling of the liquid crystalline compound-containing layer to a temperature lower than a liquid crystal temperature of the liquid crystalline compound-containing layer.

5. The method according to claim 1,
wherein in the process step (1), the liquid crystalline compound-containing layer is formed on the transparent base by a method in which a solution of the liquid crystalline compound is applied to the transparent base and dried or a method in which a melt of the liquid crystalline compound is applied to the transparent base.

6. The method according to claim 1,
wherein in the process step (2), the liquid crystalline compound-containing layer is heated to a liquid crystal temperature of the liquid crystalline compound-containing layer or higher, and the alignment substrate is brought into contact with the liquid crystalline compound-containing layer in this state; or the liquid crystalline compound-containing layer is brought into contact with the alignment substrate, and the liquid crystalline compound-containing layer in this state is heated to the liquid crystal temperature or higher.

7. The method according to claim 1,
wherein the transparent base has an optical anisotropy.

8. The method according to claim 1,
wherein the transparent base is a transfer band-like transparent base, and the process steps (1) to (4) are performed continuously at the same time that feeding of the transparent base is performed continuously.

9. The method according to claim 1,
wherein the alignment substrate is a transfer band-like alignment substrate, and the process steps (2) to (4) are performed continuously at the same time that feeding of the alignment substrate is performed continuously.

10. The method according to claim 8,
wherein at least one of the transparent base and the alignment substrate is fed out using a roller.

11. The method according to claim 8, further comprising a process step (5) of winding up the retardation plate.

12. A retardation plate that is produced by the method according to claim 1.

13. An optical element comprising the retardation plate according to claim 12 and a polarizer.

14. The optical element according to claim 13, further comprising a transparent protective film,
wherein the transparent protective film is arranged between the retardation plate and the polarizer.

15. The optical element according to claim 13, further comprising at least one adhesive layer,
wherein all or part of components of the optical element are laminated with the adhesive layer interposed between two of the components.

16. A liquid crystal panel comprising the retardation plate according to claim 12, wherein the retardation plate is arranged on one surface or both surfaces of the liquid crystal cell.

17. An image display apparatus comprising the retardation plate according to claim 12.

18. A liquid crystal display comprising the retardation plate according to claim 12.

19. The method according to claim 9,
wherein at least one of the transparent base and the alignment substrate is fed out using a roller.

20. The method according to claim 9, further comprising a process step (5) of winding up the retardation plate.

21. A liquid crystal panel comprising the optical element according to claim 13, wherein the optical element is arranged on one surface or both surfaces of the liquid crystal cell.

22. An image display apparatus comprising the optical element according to claim 13.

23. A liquid crystal display comprising the optical element according to claim 13.

24. A liquid crystal display comprising the liquid crystal panel according to claim 16.

25. A liquid crystal display comprising the liquid crystal panel according to claim 19.
